(19) United States
(12) Patent Application Publication
(10) Pub. No.: US 2008/0102395 A1
(43) Pub. Date: May 1, 2008

(54) TONER AND MANUFACTURING METHOD THEREOF

(75) Inventors: Ken OHMURA, Tokyo (JP); Hiroshi YAMAZAKI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/867,225

(22) Filed: Oct. 4, 2007

(30) Foreign Application Priority Data
Oct. 31, 2006 (JP) 2006295975

(51) Int. Cl. G03G 9/087

(52) U.S. Cl. 430/109.4

(57) ABSTRACT

An objective is to provide toner by which high quality images can be stably formed for a long duration. Disclosed is a toner possessing toner particles each containing a binder resin and a colorant, wherein the toner particle has a low surface energy group chemically bonded to the binder resin on a surface of the toner particle. It is preferable that the low surface energy group is an aliphatic hydrocarbon group, and the binder resin is urea-modified polyester. Also disclosed is a method of manufacturing a toner containing toner particles each containing a binder resin and a colorant, comprising the step of chemically reacting a compound possessing a reactive substituent and the aliphatic hydrocarbon group on the toner particle surface to chemically combine the aliphatic hydrocarbon group with the binder resin via the reactive substituent on the toner particle surface.

### TECHNICAL FIELD

The present invention relates to toner used in an electrophotographic image forming method and a manufacturing method thereof.

### BACKGROUND

The electrophotographic image forming apparatus is expanding in application and is utilized as a conventional copier or a printer for from in-house printing documents and simple copy sheets to those outside the office. The application of the electrophotographic image forming apparatus is specifically expanding to the market of on-demand printing (POD) included in a light printing field, since variable information from electronic data can be simply printed. This POD market is very much focused on images to be stably formed. That is, in conventional image formation, attention to printing itself has been paid, but in the light printing field, high quality images are demanded since much attention to the value of the resulting printed matter itself is paid in the light printing field.

In order to acquire stable image formation via an electrophotographic technique, commonly known are a method of preventing degradation of toners by using external additives (refer to Patent Document 1, for example), and a method of stabilizing transferability by coating a lubricant onto a photoreceptor or such (refer to Patent Document 2, for example).

In these methods, stable images can be obtained in the short run, but there are problems such that addition of external additives is not effective in cases when toner itself is deteriorated, and also stable images tend hardly to be obtained for a long duration since no transfer stability with external additives can be maintained, in cases when a trouble in which external additives are embedded into a photoreceptor is generated. Further, it is well known that a lubricant is coated onto a photoreceptor to improve transferability and to achieve high image quality, but in this case, there is still a problem such that no effect can be obtained for a long duration, in cases when variation of external additives is generated in the toner itself.

On the other hand, various preferable polyester resins employed as toner binder resins for color images are disclosed, and recently disclosed has been a method of producing toner via coagulation of polyester resin particles in an aqueous medium (refer to Patent Document 3, for example). However, a problem concerning image variation caused by deterioration of toner itself has not yet been solved, even though the toner employing this polyester resin is used.

(Patent Document 1) Japanese Patent O.P.I. Publication No. 7-175256

(Patent Document 2) Japanese Patent O.P.I. Publication No. 2005-181742

(Patent Document 1) Japanese Patent O.P.I. Publication No. 2005-62902

### SUMMARY

The present invention was made on the basis of the above-described situation. It is an object of the present invention to provide a toner by which high quality images can be stably formed for a long duration, and a manufacturing method thereof.

An aspect of the invention is a toner comprising toner particles each containing a binder resin and a colorant, wherein the toner particle has an aliphatic hydrocarbon group chemically bonded to the binder resin on the toner particle surface, and the binder resin is urea-modified polyester.

Another aspect of the invention is a toner comprising toner particles each containing a binder resin and a colorant, wherein the toner particle has an aliphatic hydrocarbon group on the toner particle surface.

Still another aspect of the invention is a method of manufacturing a toner containing toner particles each containing a binder resin and a colorant, comprising the step of chemically reacting a compound possessing a reactive substituent and the aliphatic hydrocarbon group on the colored particle surface to chemically combine the aliphatic hydrocarbon group with the binder resin via the reactive substituent on the toner particle surface.

In order to obtain high quality images stably for a long duration, stable transferability is desired to be acquired for a long duration. Specifically, it is known that transferability of toner from a photoreceptor or an intermediate transfer member is desired to be stable, and the stable transferability can be obtained by producing toner particles themselves having low surface energy. Thus, for example, toner particles having low surface energy can be produced by attaching a so-called fluorine based material onto the toner particle surface, but this method produces a problem such that an offset phenomenon caused by electrostatic adhesion via negative electrification during fixation is generated, since toner particles tend to exhibit excessively negative electrification. Further, for example, toner particles having low surface energy can also be produced by attaching a lubricant component such as wax onto the toner particle surface, but this method produces a problem such that the soft lubricant component is moved from the toner particle surface to the photoreceptor or the intermediate transfer member, whereby spot-shaped or strip-shaped image defects are generated in the resulting image. After considerable effort during intensive studies, the inventors have found out that no above-described problem is caused by producing the toner particle having an aliphatic hydrocarbon group as a low surface energy group chemically bonded to the binder resin on the toner particle surface to obtain stable transferability for a long duration, resulting in completion of toner of the present invention.

### DETAILED DESCRIPTION OF THE INVENTION

An aspect of the present invention is a toner comprising toner particles each containing a binder resin and a colorant, and the toner particle has a low surface energy group chemically bonded to the binder resin on the toner particle surface. As a specific embodiment of such the toner, a toner can be provided, wherein the low surface energy group is an aliphatic hydrocarbon group, and further, the foregoing binder is urea-modified polyester.

When the binder is urea-modified polyester, negative electrification possessed by polyester itself is relaxed by presence of a urea bond. Accordingly, it is preferable that high electrification stability can be obtained since the resulting toner is not charged excessively, and high adhesiveness to a recording material can also be obtained. It is preferable that a binder is urea-modified polyester, since both an ester bond and a urea bond are formed in a molecule, whereby toner particles are to possess high internal coagulation power to obtain crushability resistance.

Described will be the following toner in which the low energy group is an aliphatic hydrocarbon group, and further, the binder resin is urea-modified polyester.

### [Urea-Modified Polyester]

The urea-modified polyester constituting the binder resin in this toner preferably has a reactive functional group in order to chemically bond the aliphatic hydrocarbon group. This reactive functional group is not specifically limited, provided that reaction can be produced with a reactive aliphatic hydrocarbon compound associated with the aliphatic hydrocarbon group. Specific examples of the reactive functional group include a hydroxyl group, a carbonyl group, an isocyanate group and an amino group.

As described later in detail, the urea-modified polyester in which the reactive functional group is an isocyanate group can be obtained in a state where the polyester molecule is stretched by the urea bond, and at the same time, the isocyanate group remains at the terminal, by reacting a small amount of polyamine as an amine crosslinking agent with a segment of isocyanate-modified polyester. In this method, an isocyanate group as a reactive functional group together with, at the same time, formation of polyester having a urea bond is formed, whereby a reactive functional group can be reliably formed.

A segment of isocyanate-modified polyester to acquire urea-modified polyester may be crystalline or amorphous. When crystalline isocyanate-modified polyester (hereinafter, referred to as “isocyanate-modified crystalline polyester”) and amorphous isocyanate-modified polyester (hereinafter, referred to as “isocyanate-modified amorphous polyester”) as a segment of isocyanate-modified polyester are used in combination, the content of the segment of isocyanate-modified crystalline polyester is preferably 4-48% by weight, based on the entire urea-modified polyester, and more preferably 5-30% by weight.

### [Isocyanate-Modified Polyester Component]

A segment of isocyanate-modified polyester to acquire urea-modified polyester is isocyanate-modified by reacting a crystalline or amorphous polyester with a polyisocyanate compound, namely a polyester in which the hydroxyl group or carboxyl group at the molecular terminal thereof is replaced by an isocyanate group capable of reacting with an active hydrogen-containing group.

The crystalline polyester to acquire isocyanate modified polyester is a polyester having a melting point (Tm) within a specified temperature range and formed by polycondensation of an aliphatic diet (OH—R¹—OH) and an aliphatic dicarboxylic acid (HOOC—R²—COOH), which has simple molecular structure and high crystallinity and exhibits sharp melting property. The hydrocarbon group R¹ constituting the aliphatic diet and that R² constituting the aliphatic dicarboxylic acid are each a linear or branched hydrocarbon group having 2-12 carbon atoms or a cyclic hydrocarbon group, and an ether bond may be contained in the hydrocarbon group.

The specified temperature range relating to melting point (Tm) of the crystalline polyester is from 30 to 99° C. and specifically preferably from 45 to 88° C. Melting point (Tm) of the crystalline polyester is the temperature at the top of endothermic peak which is measured by differential scanning calorimetry using a differential scanning calorimeter DSC-7 and a calorimetry controller TAC 7/DX, each manufactured by Perkin-Elmar, Inc. In concrete, 4.5 mg of the toner was enclosed in an aluminum pan (Kit No. 0219-0041) and set on the sample holder of DSC-7, and then subjected to heat-cool-heat temperature control in a measuring temperature range of 0-200° C., a heating rate of 10° C./minute and a cooling rate of 10° C./minute. The analysis was carried out according to the data at the second heating. An empty aluminum pan was used for a reference. When no endothermic peak is obtained by DSC measurement of urea-modified polyester, Melting point (Tm) of the crystalline polyester can be confirmed by isolating the segment of isocyanate-modified crystalline polyester from the urea-modified polyester and carrying out the DSC measurement on the segment. The isocyanate-modified polyester segment can be isolated by hydrolyzing the urea-modified polyester by heating for 6 hours together with a strong acid such as concentrated hydrochloric acid.

Tetrahydrofuran (THF) soluble segment of such the crystalline polyester preferably has a number average molecular weight (Mn) of 100-10,000, more preferably 800-5,000, and a weight average molecular weight of 1,000-50,000, and more preferably 2,000-30,000, which are measured by gel permeation chromatography (GPC).

The measurement of the molecular weight by GCP is carried out as follows. A GCP apparatus HCL-8220, manufactured by Toso Co., Ltd., and columns, TSK Guard Column+triplet TKS Gel Super HZM-M, manufactured by Toso Co., Ltd., are used, and tetrahydrofuran (THF) as a carrier solvent is flowed at a flowing rate of 0.2 ml/min. while maintaining the column temperature at 40° C. The sample to be measured is dissolved in tetrahydrofuran in a concentration of 1 mg/ml by an ultrasonic dispersing machine for five minutes at room temperature and filtered through a membrane filter having a pore size of 0.2 μm to obtain a sample solution. Ten micro liter of the resultant sample solution is injected into the measuring apparatus together with the carrier solvent and detected by a refractive index detector (RI detector). The molecular weight distribution of the sample is calculated according to a calibration curve prepared by using monodisperse polystyrene standard particles. As the standard polystyrene samples for preparing the calibration curve, ones each having a molecular weight of 6×10², 2.1×10³, 4×10³, 1.75×10⁴, 5.1×10⁴, 1.1×10⁵, 3.9×10⁵, 8.6×10⁵, 2×10⁶ and 4.48×10⁶, each manufactured by Pressure Chemical Co., Ltd., are used, and at least 10 kinds of the standards samples were subjected to the determination for preparing the calibration curve. A refractive index detector is used as the detector.

As a preferable example of such the isocyanate-modified crystalline polyester, an isocyanate-modified polyalkylene polyester is cited. Specific examples thereof include polyethylene sebacate, polyethylene adipate, polyhexamethylene sebacate, polyoctamethylene dodecanedioate, polyhexamethylene-decamethylene sebacate and polyoxydecamethylene-2-methyl-1,3-propane dodecanedioate. These may be used singly or in combination with at least two kinds.

Examples of the aliphatic diol to form the crystalline polyester as the isocyanate-modified crystalline polyester include ethylene glycol, diethylene glycol, triethylene glycol, 1,2-propylene glycol, 1,3-propylene glycol, 1,4-butanediol, 1,4-butenediol, neopentylglycol, 1,5-pentane glycol, 1,6-hexane glycol, 1,7-heptane glycol, 1,8-octanediol, 1,9-nonanediol, 1,10-decanediol, 1,4-cyclohexanediol and dipropylene glycol. These may be used singly or in combination with at least two kinds. In order to adjust the melting point, in addition to such aliphatic diol, aliphatic polyol having trivalent or more may also be used when the isocyanate-modified crystalline polyester component is polymerized. Examples of such an aliphatic polyol include glycerin, trimethylolethane, trimethylol propane, pentaerythritol, sorbitol, phenol novolac, cresol novolac, and alkylene oxide adducts thereof. The using ratio of the aliphatic polyol having trivalent or more is preferably 1-30% by weight, more preferably 2-30% by weight, based on the total amount of the polyols including the aliphatic diol. When the using ratio of the aliphatic polyol is less than 1% by weight based on the total amount of the aliphatic polyol, effect of controlling the melting point by the polyol cannot be sufficiently obtained. When the using ratio of the aliphatic polyol exceeds 40% by weight of the total amount of the aliphatic polyol including the aliphatic diol, formed polyester is not crystalline.

Examples of the aliphatic dicarboxylic acid to form the crystalline polyester as the isocyanate-modified crystalline polyester include oxalic acid, malonic acid, succinic acid, glutaric acid, adipic acid, suberic acid, azelaic acid, sebacic acid, pimelic acid, citraconic acid, maleic acid, fumalic acid, itaconic acid, glutaconic acid, iso-dodecylsuccinic acid, iso-dodecenylsuccinic acid, n-dodecylsuccinic acid, n-dodecenylsuccinic acid, n-octylsuccinic acid, n-octenylsuccinic acid, acid anhydrides thereof and chlorides thereof. These may be used singly or in combination with two kinds. Additionally to the above aliphatic acids, a small amount of polycarboxylic acid such as trimellitic acid, pyromellitic acid, their acid anhydrate and chloride may be employed to form the isocyanate-modified crystalline polyester for controlling the melting point. The using ratio of the tri- or more polycarboxylic acid is preferably 0.1-30% by weight, more preferably 0.2-5% by weight, based on the total amount the carboxylic acid including the aliphatic dicarboxylic acid. When the using ratio of the polycarboxylic acid is less than 0.1% by weight based on the total amount including the aliphatic dicarboxylic acid, effect of controlling the melting point by the polycarboxylic acid cannot be sufficiently obtained. When the using ratio of the polycarboxylic acid exceeds 30% by weight of the total amount including the aliphatic dicarboxylic acid, formed polyester is not crystalline.

The using ratio of the aliphatic diol to the amount of the aliphatic dicarboxylic acid is preferably 1.5/1-1/1.5, and more preferably 1.2/1-1/1.2 in an equivalence ratio of [OH]/[COOH] of the hydroxyl group [OH] of the aliphatic diol to the carboxylic group [COOH] of the aliphatic dicarboxylic acid. The isocyanate-modified crystalline polyester having desired molecular weight can be surely obtained when the ratio of the aliphatic diol to the aliphatic dicarboxylic acid is within the above range.

As the polyisocyanate compound to be used for isocyanate-modifying the crystalline polyester, an aliphatic polyisocyanate compound such as tetramethylene diisocyanate, hexamethylene diisocyanate and 2,6-diisocyanatemethyl caproate; an alicyclic polyisocyanate compound such as isophorone diisocyanate and cyclohexylmethane diisocyanate; an aromatic diisocyanate such as trilene diisocyanate and diphenylmethane diisocyanate; an aromaliphatic diisocyante such as α, α, α′, α′-tetramethylxylene diisocyanate; an isocyanulate, phenol derivatives of such the polyisocyanate compounds; and compounds formed by blocking each of the polyisocyanate compounds by oxime or caprolactum can be cited. The above compounds may be used singly or in combination with at least two kinds.

### Isocyanate-Modified Amorphous Polyester

The amorphous polyester to acquire isocyanate-modified polyester means a polyester other than the above described crystalline polyester, which usually has no melting point (Tm) and has relatively high glass transition temperature (Tg). The amorphous polyester can be obtained by polycondensation of a polyol and a polycarboxylic acid.

Glass transition temperature (Tg) of the amorphous polyester is preferably 20-90° C., and specifically preferably 35-65° C. The softening temperature of the amorphous polyester is preferably 80-220° C., and specifically preferably 80-150° C. Glass transition temperature (Tg) of the amorphous polyester is measured by a differential scanning calorimeter DSC-7 and a calorimetric analysis apparatus controller TAC 7/DX, each manufactured by Perkin-Elmar, Inc. In concrete, 4.50 mg of the toner was enclosed in an aluminum pan (Kit No. 0219-0041) and set on the sample holder of DSC-7, and then subjected to heat-cool-heat temperature control in a measuring temperature range of 0-200° C., a heating rate of 10° C./minute and a cooling rate of 10° C./minute. An empty aluminum pan was used for a reference. Data at the second heating were obtained and glass transition temperature (Tg) is expressed by the crossing point of the prolongation of the base line before the rising up of the first endothermic peak and the tangent line at the largest slant point between the rising up portion of the first endothermic peak and the summit of the peak. In the course of the first heating, the temperature was maintained at 200° C. for 5 minutes. The softening temperature is measured as follows. Under the condition of 20° C. and 50% RH, 1.1 g of the toner is put into a Petri dish and evened, and then stood for 12 hours or more. After that, the toner was pressed by a pressure of 3820 kg/cm for 30 seconds by a molding machine SSP-10A, manufactured by Shimadzu Seisakusho Co., Ltd., to prepare a tablet of the sample having a diameter of 1 cm. Then the sample tablet was extruded through a hole of cylindrical die (1 mm in diameter×1 mm) by a piston having a diameter of 1 cm under conditions of a load of 196 N (20 kgf), an initial temperature of 60° C., a preliminary heating for 300 seconds and a heating rate of 6° C./min. using a flow tester CFT-500D, manufactured by Shimadzu Seisakusho Co., Ltd. The environmental condition was conditioned at 24° C. and 50% of RH. An offset temperature T_{offset} measured by melting temperature measuring method according to temperature raising method with setting the offset value at 5 mm was defined as the softening temperature of the toner.

THF soluble component of such the amorphous polyester preferably has a number average molecular weight (Mn) of from 2,000 to 10,000, more preferably 2,500-8,000, and a weight average molecular weight (Mn) of 3,000-100,000, and more preferably 4,000-70,000, which are measured by gel permeation chromatography (GPC).

The measurement of the molecular weight by GCP is carried out as follows. A GCP apparatus HCL-8220, manufactured by Toso Co., Ltd., and columns, TSK Guard Column+triplet TKS Gel Super HZM-M, 3 columns, manufactured by Toso Co., Ltd., are used, and tetrahydrofuran (THF) as a carrier solvent is flowed at a flow rate of 0.2 ml/min. while maintaining the column temperature at 40° C. The sample to be measured is dissolved in tetrahydrofuran in a concentration of 1 mg/ml by an ultrasonic dispersing machine for five minutes at room temperature and filtered through a membrane filter having a pore size of 0.2 μm to obtain a sample solution. Ten μL of the resultant sample solution is injected into the measuring apparatus together with the carrier solvent and detected by a refractive index detector (RI detector). The molecular weight distribution of the sample is calculated according to a calibration curve prepared by using monodisperse polystyrene standard particles. As the standard polystyrene samples for preparing the calibration curve, those each having a molecular weight of 6×10², 2.1×10³, 4×10³, 1.75×10⁴, 1.1×10⁵, 3.9×10⁵, 8.6×10⁵, 2×10⁶ and 4.48×10⁶, each manufactured by Pressure Chemical Co., Ltd., are used, and at least 10 kinds of the standards samples are subjected to the determination for preparing the calibration curve. A refractive index detector is used as the detector.

As the polyol for forming the amorphous polyester of the isocyanate-modified amorphous polyester, for example, a bisphenol such as bisphenol A and bisphenol F; and an alkylene oxide adduct of a bisphenol such as an ethylene oxide adduct thereof and a propylene oxide adduct thereof, can be cited additionally to the foregoing aliphatic diols. As the tri- or more polyhidric alcohol, glycerol, trimethylopropane, pentaerythlitol and sorbitol are cited. Moreover, cyclohexanedimethanol and neopentyl alcohol are preferably used from the viewpoint of production cost and the environmental suitability. These alcohols can be used singly or in combination with at least two kinds.

As the polycarboxylic acid to form the amorphous polyester of the isocyanate-modified amorphous polyester, an aromatic dicarboxylic acid such as phthalic acid, iso-phthalic acid, terephthalic acid and naphthalene dicarboxylic acid additionally to the foregoing aliphatic dicarboxylic acids are cited. Moreover, a tri- or more polycarboxylic acid such as trimellitic acid and pyromellitic acid may be used for suitably controlling the viscosity in state of the urea-modified polyester. These carboxylic acids can be used singly or in combination with two kinds.

As the polyisocyanate compound to isocyanate-modify the amorphous polyester, those to be employed to isocyanate-modify the foregoing crystalline polyester are usable.

### Polyamine

Examples of the polyamine for urea-bonding the segment of isocyanate-modified polyester include a diamine, for example, an aromatic diamine such as phenylenediamine, diethyltoluenediamine, 4,4′-diaminodiphenylmethane, an alicyclic diamine such as 4,4′-diamino-3,3′-dimethyl-dicyclohexylmethane, diaminecyclohexane and isopholonediamine, and an aliphatic diamine such as ethylenediamine, tetramethylenediamine and hexamethylenediamine; a tri- or more polyamine such as diethylenetriamine and triethylenetetramine; an amino alcohol such as ethanolamine and hydroxyethylaniline; an aminomercaptane such as aminoethylmercaptane and aminopropylmercaptane; an aminoic acid such as aminopropionic acid and aminocapronic acid; a ketoimine compound formed by blocking the amino group of the above aminoic acid by reaction with a ketone such as acetone, methyl ethyl ketone and methyl isobutyl ketone; and an amino-blocked compound such as oxasolyzone compound. These compounds can be used singly or in combination with at least two kinds. In the present invention, diamine compounds are preferably used as the polyamine. However, the diamine compound and a small amount of the tri- or more polyamine may be mixed for suitably controlling the viscosity of the urea-modified polyester in melted state, because possibly, the toner cannot be highly uniformly charged when unreacted amino terminals remain in the resulting urea-modified polyester.

The weight average molecular weight of the urea-modified polyester is preferably 5,000-500,000 and more preferably 10,000-100,000, and the number average molecular weight of that is preferably 3,500-400,000 and more preferably 7,000-80,000. Sufficient low temperature fixing ability and high adhesion ability to the recording material by the urea-modification of the crystalline polyester and the amorphous polyester can be obtained, and the crushing of the toner in the developing apparatus is inhibited and the strength of resultant image can be raised when molecular weight of the urea-modified polyester is within the above range. When the molecular weight of the urea-modified polyester is too low, the viscosity in melted state is lowered and the strength of the toner particle itself is lowered some degree so that the possibility is posed that toner particle tends to be crushed by stress in the developing apparatus and the strength of the fixed image is lowered even though the sufficient low temperature fixing ability can be obtained. When the molecular weight of the urea-modified polyester is excessively high, the viscosity in melted state is made higher and the adhesion strength onto the recording material tends to be insufficient.

The molecular weight of the urea-modified polyester can be measured by gel permeation chromatography (GPC) of the THF soluble component. A GCP apparatus HCL-8220, manufactured by Toso Co., Ltd., and columns, TSK Guard Column+triplet TKS Gel Super HZM-M, 3 columns, manufactured by Toso Co., Ltd., are used, and tetrahydrofuran (THF) as a carrier solvent is flowed at a flow rate of 0.2 ml/min. while maintaining the column temperature at 40° C. The sample to be measured is dissolved in tetrahydrofuran in a concentration of 1 mg/ml by an ultrasonic dispersing machine for five minutes at room temperature and filtered through a membrane filter having a pore size of 0.2 μm to obtain a sample solution. Ten micro liters of the resulting sample solution are injected into the measuring apparatus together with the carrier solvent and detected by a refractive index detector (RI detector). The molecular weight distribution of the sample is calculated according to a calibration curve prepared by using monodisperse polystyrene standard particles. As the standard polystyrene samples for preparing the calibration curve, ones each having a molecular weight of 6×10², 2.1×10³, 4×10³, 1.75×10⁴, 5.1×10⁴, 1.1×10⁵, 39×10⁵, 8.6×10⁵, 2×10⁶ and 4.48×10⁶, each manufactured by Pressure Chemical Co., Ltd., are used, and at least 10 kinds of the standards samples are subjected to the determination for preparing the calibration curve. A refractive index detector is used as the detector.

The acid value of the urea-modified polyester is also preferably 5-45 mg KOH/g and more preferably 5-30 mg KOH/g. When the acid value of the urea-modified polyester is too high, the image formation under high temperature-high humidity condition or low temperature-low humidity condition is easily influenced by the environmental condition and possibility of deterioration of image is caused.

Glass transition temperature (Tg) of the urea-modified polyester is preferably 30-60° C., and more preferably 35-54° C., and a softening temperature is preferably 70-110° C., and more preferably 80-100° C. The glass transition temperature and the softening temperature are each measured by the foregoing methods.

### [Reactive Aliphatic Hydrocarbon Compound]

An aliphatic hydrocarbon group that is present on the surface of a toner particle constituting the toner of the present invention is associated with a reactive aliphatic hydrocarbon compound. This reactive aliphatic hydrocarbon compound has a reactive substituent and an aliphatic hydrocarbon group. This reactive substituent can be reacted with urea-modified polyester constituting a binder resin for colored particles to form toner particles. Specific examples thereof include a hydroxyl group, a carbonyl group, an isocyanate group and an amino group.

The number of carbon atoms possessed by the aliphatic hydrocarbon group in the reactive aliphatic hydrocarbon compound is preferably close to the number of carbon atoms possessed by an alkyl compound commonly utilized as a lubricant. For example, a saturated hydrocarbon group having 8-30 carbon atoms is preferable, and a saturated hydrocarbon group having 12-25 carbon atoms is more preferable. Specifically, it is not branched but preferably straight-chained. Specific examples thereof include long chain aliphatic alcohol such as dodecyl alcohol, hexadecyl alcohol, octadecyl alcohol, eicosyl alcohol, docosyl alcohol or octacosyl alcohol; long chain aliphatic amine such as dodecyl amine, hexadecyl amine, octadecyl amine, eicosyl amine, docosyl amine or octacosyl amine; and a long chain aliphatic carboxylic acid such as a dodecanoic acid, a hexadecanoic acid, an octadecanoic acid, an eicosanoic acid, a docosanoic acid or an octacosanoic acid.

A preferable combination of a reactive functional group in a binder resin and a reactive substituent in a reactive aliphatic hydrocarbon compound is one in which the reactive functional group relating to a binder is an isocyanate group, and the reactive substituent relating to a reactive aliphatic hydrocarbon compound is a hydroxyl group, a carbonyl group, or an amino group. The reason is that the aliphatic hydrocarbon group is possible to be firmly fixed on the surface of the toner particle, since an isocyanate group exhibits high reactivity.

As an addition amount of this reactive aliphatic hydrocarbon compound, the amount by which a layer of an aliphatic hydrocarbon group is formed on the surface of a colored particle containing a binder resin and a colorant is good enough. Specifically, an addition amount of this reactive aliphatic hydrocarbon compound is so that toner has the aliphatic hydrocarbon group in an amount of 0.01-5% by weight, based on the weight of the total toner particles, and preferably in an amount of 0.1-2% by weight.

### [Method of Manufacturing Toner]

The above-described toner can be prepared via a method of manufacturing a toner comprising colored particles each containing a binder resin and a colorant, comprising the step of chemically reacting a compound possessing a reactive substituent and an aliphatic hydrocarbon group on the toner particle surface to chemically combine the aliphatic hydrocarbon group with the binder resin via the reactive substituent on the colored particle surface.

As an example of a manufacturing method of toner including the following processes: (1) isocyanate-modified polyester synthesizing process in which polyester is synthesized to prepare a segment of the isocyanate-modified polyester to isocyanate-modify this polyester, (2) process for preparing material liquid for toner formation in which a binder resin constituent formed from a segment of isocyanate-modified crystalline polyester, an amine crosslinking agent, a colorant, and a toner constituting material such as wax or a charge control agent, if desired, is dissolved or dispersed in an organic solvent, (3) process of producing colored particles in which the colored particles containing the colorant and, wax and charge controlling agent if desired are produced by forming the urea-modified polyester via crosslinking treatment using an amine crosslinking agent, (4) process of controlling shape of the resulting colored particles, (5) surface reaction process in which an aliphatic hydrocarbon group is chemically bonded to the colored particle surface by adding a reactive aliphatic hydrocarbon compound into shape-controlled colored particles, (6) solvent removal process in which an organic solvent is removed from the toner mother particles in the state where the aliphatic hydrocarbon group is fixed and bonded to the surface, (7) filtering and washing process to filtrate the toner mother particles from the aqueous medium and washing to remove the surfactant from the particles, (8) drying process for drying the toner mother particles, and (9) external additive addition process to obtain the toner particles by adding external additives to the dried toner mother particles.

### (1) Isocyanate-Modified Polyester Synthesizing Process

The isocyanate-modified crystalline polyester synthesizing process is a process for synthesizing the isocyanate-modified polyester segment using the aliphatic diol and the aliphatic dicarboxylic acid to form the urea-modified polyester to be a binder resin material constituting toner particles. In concrete, polydiol and a polycarboxylic acid are heated at a temperature of from 150 to 280° C. in the presence of a catalyst such as tetrabutoxy titanate or dibutyl tin oxide and formed water is distilled off, under reduced pressure if desired, to produce polyester having a hydroxyl group and/or a carboxyl group. And then the polyisocyanate compound is reacted to the polyester at a temperature of 40-280° C. for substituting the hydroxyl group and/or carboxyl group at the molecular terminal of the polyester by the isocyanate group to obtain the isocyanate-modified crystalline polyester segment. On the occasion of the reacting the polyisocyanate compound, a solvent inactive to the polyisocyanate compound, for example, a ketone such as acetone, methyl ethyl ketone and methyl iso-butyl ketone; an ester such as ethyl acetate, an amide such as dimethylformamide and dimethylacetoamide; an ether such as tetrahydrofuran; and an aromatic solvent such as toluene and xylene, may be used, if desired.

### (2) Process for Preparing Material Liquid for Toner Formation

The process for preparing a material liquid for toner formation is a process for preparing a material liquid for producing toner by dissolving or dispersing a binder resin constituent formed from a segment of isocyanate-modified polyester and an amine crosslinking agent, and the toner constituting materials including a colorant, and wax and charge controlling agent, if desired, in an organic solvent. A catalyst such as dibutyl tin laurate or dioctyl tin laurate may be added into a toner forming material liquid, if desired.

As the organic solvent to be used for preparing the toner forming material liquid, one having low boiling point and low solubility in water is preferable from the viewpoint of that the solvent can be easily removed after formation of the colored particles. In concrete, for example, methyl acetate, ethyl acetate, methyl ethyl ketone, methyl iso-butyl ketone, toluene and xylene can be cited. These solvents may be used singly or in combination of two or more kinds thereof. The consumption amount of the organic solvent is usually 1-300, preferably 1-100, and more preferably 25-70, parts by weight, based on 100 parts by weight of the binder resin constituent.

The colorant constituting the toner of the present invention is not specifically limited and carbon black, a magnetic material, a dye and a pigment are optionally usable. As the carbon black, channel black, furnace black, acetylene black, thermal black and lamp black are usable. As the magnetic material, a ferromagnetic metal such as iron, nickel and cobalt, an alloy containing such the metal, a compound of ferromagnetic metal such as ferrite and magnetite, an alloy exhibiting ferromagnetism by heat treatment even though containing no ferromagnetic metal such as an alloy called Heusler alloy, for example, a manganese-copper-aluminum alloy and a manganese-copper-tin alloy, and chromium dioxide are usable. As the dye, C. I. Solvent Red 1, 49, 52, 58, 63, 111 and 122, C. I. Solvent Yellow 19, 44, 77, 79, 81, 82, 93, 98, 103, 104, 112 and 162, and C. I. Solvent Blue 25, 36, 60, 70, 93 and 95, are usable. A mixture of them also can be used. As the pigment, C. I. Pigment Red 5, 48:1, 53:1, 57:1, 122, 139, 144, 149, 166, 177, 178 and 222, C. I. Pigment Orange 31 and 43, C. I. Pigment Yellow 14, 17, 74, 93, 94, 138, 155, 180 and 185, C. I. Pigment Green 7 and C. I. Pigment Blue 15:3 and 60, are usable. A mixture of them also is usable.

Various kinds of known wax can be used without any specific limitation. For example, a hydrocarbon type wax such as low molecular weight polyethylene wax, low molecular weight polypropylene wax, Fischertropush wax, microcrystalline wax and paraffin wax, and an ester type wax such as carnauba wax, pentaerythlitol behenate and behenyl citrate can be cited. These waxes may be used singly or in combination with at least two kinds.

Various kinds of known charge controlling agent can be used without any limitation. Concretely, nigrosine type dye, a metal salt of naphthenic acid or a higher fatty acid, an alkoxylized amine, a quaternary ammonium chloride, an azo type metal complex, a metal salicylate and a metal complex thereof are usable.

As to a toner forming material liquid, the content of colorant is 1 to 15% by weight, and preferably 4-10% by weight, based on the total solid content in the toner forming material liquid. When the toner forming material liquid contains the wax, content of the wax is, for example, 2-20% by weight, and preferably 3-18% by weight, based on the total solid content in the toner forming material liquid. When the toner forming material liquid contains a charge controlling agent, the content of the charge controlling agent is, for example, 0.1-2.5% by weight, and preferably 0.5-2.09% by weight, based on the total solid content in the toner forming material liquid.

### (3) Process of Producing Colored Particles

In this process, the above prepared toner forming material liquid is added and dispersed in an aqueous medium to form oil droplets controlled in such a way the particle diameter of the resulting colored particles becomes a desired particle size. In the droplet, an isocyanate group in a segment of isocyanate-modified polyester is crosslinked by an amine crosslinking agent to form a urea bond, whereby urea-modified polyester is produced, colored particles containing colorants, and wax if desired, in a binder resin formed from this urea-modified polyester are produced, and an organic solvent is removed after terminating the crosslinking reaction in this process.

In which the colorant and, according to necessity, the wax are contained. And then the organic solvent is removed after completion of the crosslinking reaction. In this process, the resulting urea-modified polyester has the isocyanate group remaining at the terminal.

In the above-described (2) process for preparing material liquid for toner formation and (3) process of producing colored particles, the amine crosslinking agent is previously added into the oil droplet (toner forming material liquid) in the aqueous medium. However, another method can be applied, in which the amine crosslinking agent is added into the aqueous medium after formation of oil droplets by dispersing the toner forming material liquid containing no amine crosslinking agent in the aqueous medium. In such the case, the amine crosslinking agent is supplied to the oil droplets from the aqueous medium, and as to the oil droplets, urea-modified polyester is produced by forming the urea bond via crosslinking reaction of the isocyanate group of the isocyanate-modified polyester with the amine crosslinking agent.

Emulsification of the toner forming material liquid can be conducted by using mechanical energy. As a homogenizer for the emulsification, a low speed shear homogenizer, a high speed shear homogenizer, a friction type homogenizer, a high pressure jet type homogenizer and an ultrasonic homogenizer are applicable without any specific limitation. In concrete, TK model Homomixer, manufactured by Tokushu Kika Kogyo Co., Ltd., can be cited. The number average primary particle diameter of the droplets in a dispersion state is preferably 60-1,000 nm, and more preferably 80-500 nm. The number average primary particle diameter of the droplets was measured employing an electrophoretic light scattering photometer “ELS-800” (Otsuka Electronic Co., Ltd.).

The “aqueous medium” is defined as a medium containing water in a content of al least 50% by weight. As the component other than water, a water-soluble organic solvent such as methanol, ethanol, iso-propanol, butanol, acetone, methyl ethyl ketone, dimethylformamide, methyl cellosolve, and tetrahydrofuran is usable. Among them, an alcohol type organic solvent capable of not dissolving the resin such as methanol, ethanol, iso-propanol and butanol is preferably used.

The consumption amount of the aqueous medium is preferably 50-2,000 parts by weight, based on 100 parts by weight of toner forming material liquid and more preferably 100-1,000 parts by weight. The toner forming material liquid can be dispersed and emulsified into the droplets having the desirable particle diameter in the aqueous medium when the consumption amount is within the above range.

A dispersion stabilizer is dissolved in the aqueous medium. Moreover, a surfactant and a resin fine particle may be added into the aqueous medium. As the dispersion stabilizer, an inorganic compound such as tricalcium phosphate, calcium carbonate, titanium oxide, colloidal silica and hydroxyapatite is usable. One which is soluble with an acid or an alkali such as tri calcium phosphate is preferably used since it is necessary to remove the dispersion stabilizer from the colored particles, and one which is decomposable with enzyme is preferably used from the viewpoint of environment protection. Examples of the usable surfactant include an anionic surfactant such as an alkylbenzenesulfonate, an pα-olefinsulfonate and a phosphate, an amine type salt such as an alkylamine salt, an amino alcohol aliphatic acid derivative, a polyamine aliphatic acid derivative and imidazoline, a quaternary ammonium salt type cationic surfactant such as an alkyltrimethylammonium salt, a dialkyldimethylammonium salt, an alkyldimethylbenzylammonium salt, a pyridinium salt, an alkylisoquinolinium salt and benzedonium chloride, a nonionic surfactant such as a polyol derivative, and an amphoteric surfactant such as alanine, dodecyl-di(aminoethyl)glycine, di(octylaminoethyl)glycine, and N-alkyl-N,N-dimethyl-ammonium betaine. An anionic and cationic surfactant each having a fluoroalkyl group are also usable. As the resin particle for raising dispersion stability, one having a particle diameter of 0.5-3 μm is preferable. Concretely, poly(methylacrylate) resin particles having a particle diameter of 1 μm and that having a diameter of 3 μm, polystyrene resin particle having a particle diameter of 0.5 μm and that having a particle diameter of 2 μm, and polystyrene-acrylonitrile particle resin particles having a particle diameter of 1 μm are cited.

The crosslinking reaction time taken with the amine crosslinking agent, depending on the kind of the raw material and the kind of the amine crosslinking agent, is preferably, for example, 1-24 hours, and more preferably 2-15 hours. The reaction temperature is preferably 20-100° C. and more preferably 50-98° C.

The organic solvent removal treatment after terminating the crosslinking reaction is carried out by the operation in which the dispersion composed of the aqueous medium and the colored particles dispersed in the medium is gradually heated while stirring in a laminar flowing state and strongly stirred at a given temperature range, and then subjected to a solvent removal treatment. When the colored particles are formed by using the dispersion stabilizer, an acid or alkali is added to remove the dispersion stabilizer in addition to the organic solvent removal treatment.

### (4) Process of Controlling Shape of the Resulting Colored Particles

The shape controlling process is a process in which the shape of colored particles is controlled by a filter passing treatment using a filter having pores of micron order size or a stirring treatment by an annular type continuous stirring mill so that the ratio of the major axis to the minor axis of the particle is within a designated range. As the concrete method for controlling the shape of the colored particle, for example, a method in which the dispersion is passed through a gap, a filter of a fine pore and a method utilized at high speed rotation for applying centrifugal force to the colored particles to control the shape thereof are applicable. As the specific apparatus to control colored particle shape, a piston type high pressure homogenizer and an in-line screw pump other than the above0described annular type continuous stirring mill are cited. The toner particles having the designated shape can be realized by controlling time, temperature and speed of the treatment. The colored particles having the designated major/minor axis ratio can be produced by carrying out the shape controlling treatment as described above. The organic solvent removal treatment carried out after the crosslinking reaction in the urea-modified polyester formation process may be conducted after the shape controlling treatment.

### (5) Surface Reaction Process

This process is a process in which an aliphatic hydrocarbon compound-containing solution obtained by dissolving a reactive aliphatic hydrocarbon compound in an organic solvent is added into an aqueous medium dispersion of shape-controlled colored particles, and an aliphatic hydrocarbon group is chemically bonded to the surface of colored particles to elongate the urea-modified polyester molecule. In this process, the aliphatic hydrocarbon compound-containing solution is added into the above-described dispersion of colored particles while stirring, the reactive aliphatic hydrocarbon compound is adsorbed onto the surface of colored particles via this operation, and the chemical bonding is formed via reaction with an isocyanate group as a reactive functional group existing on the surface of the colored particle to obtain toner mother particles having the aliphatic hydrocarbon group chemically bonded to the binder resin on the toner particle surface. This surface reaction condition is not specifically limited, but the temperature condition is at the boiling point of water or less, for example, preferably at room temperature −90° C., and also preferably at the boiling point of utilized organic solvent or less. In this surface reaction, a higher reaction speed can be produced since a reaction system can be heated up to a boiling point or more under the common atmospheric pressure condition by accelerating the reaction under the applied pressure condition employing an autoclave.

### (6) Solvent Removal Process

In this solvent removal process, a removal solvent treatment is conducted to remove an organic solvent from toner mother particles having the aliphatic hydrocarbon group chemically bonded to the binder resin on the toner particle surface. The removal solvent treatment is also conducted by heating up to the boiling point of an organic solvent or more, and via evaporation.

### (7) Filtering and Washing Processes

In the filtering and washing processes, a filtering treatment in which the dispersion of toner mother particles is cooled and subjected to a filtering treatment for taking out the toner mother particles from the resulting cooled dispersion by solid-liquid separation, and a washing treatment in which adhering substance such as the surfactant is removed from the filtered toner mother particles (a cake-shaped aggregate) are performed. As the specific method for solid-liquid separation and washing, a centrifugal method, a vacuum filtration method using a Nutsche funnel and a filtering method using a filter press are applicable though the method is not specifically limited.

### (8) Drying Process

In the drying process, the washed toner mother particles are subjected to a drying treatment. For the drying treatment, a spray dryer, a vacuum freezing dryer, a vacuum dryer, a standing rack dryer, a mobile rack dryer, a fluid layer dryer, a rotary dryer and a stirring dryer are applicable though the dryer is not specifically limited. The moisture content of toner mother particles after the drying treatment is preferably 5% by weight or less, and more preferably not 2% by weight or less.

The measurement of the moisture content is carried out by Karl-Fischer coulometric titration. In concrete, an automatic thermal evaporation moisture measuring system AQS 724, manufactured by Hiranuma Sangyo Co., Ltd., composed of an aquameter AO-6, AQI-601 (inter face for AQ-6) and a thermal evaporation apparatus LE-24S was used. Zero point five grams of toner mother particle after standing for 24 hours in an environment of 20° C. and 50% RH is exactly weighed and put into a 20 ml sample tube and the tube is closely stopped using a silicone rubber packing coated with Teflon®, and then the moisture in the closely stopped environment is measured applying the following measuring condition and reagent. Furthermore, two empty samples are measured at the same time for calibrating the moisture in the closely stopped environment.

Sample temperature: 110° C.

Sample heating time: 1 minute

Nitrogen gas flowing rate: 150 ml/minute

Counter electrode liquid (cathode liquid): Hydranal® Coulomat CG-K

Generation liquid (anode liquid): Hydranal® Coulomat AK

When the dried toner mother particles form an aggregate by weak inter-particle attractive force, the aggregation may be subjected to a loosening treatment. As the loosening apparatus, a mechanical crushing machine such as a jet mill, HENSCHEL MIXER, a coffee mill and a food processor are applicable.

### (9) External Additive Addition Process

In this process, external additives such as the charge controlling agent, various kinds of inorganic particle, organic particle and slipping agent are added to the dried toner mother particles for improving fluidity, charging ability and cleaning ability to produce the toner. As the apparatus for adding the external additive, various kinds of known mixing apparatus such as a tabular mixer, HENSCHEL MIXER, a nautor mixer and a V-type mixer are applicable. As the inorganic fine particle, powder of an inorganic oxide compound such as silica, titania and alumina is preferable and the inorganic particles is preferably subjected to hydrophobilizing treatment by silane coupling agent or titan coupling agent. The addition amount of external additives is 0.1-5.0% by weight, and preferably 0.5-4.0%, based on the weight of toner. The external additives may be used in combination with various materials.

### [Particle Diameter of Toner Particle]

The toner particle of the present invention preferably has a volume-based median particle diameter of 3-8 μm. The diameter of the toner particle can be controlled by concentration of a coagulant and the addition amount of the organic solvent in the coagulation process, fusing time, and the composition of polyester resin. When the volume-based median particle diameter is 3-8 μm, toner particles having high adhesion which adhere onto the heated members via flying and cause offset at fixing process are reduced and the transfer efficiency of toner is increased so that the quality of halftone images, fine lines and dots are improved. The particle size distribution of the toner preferably exhibits a CV value of 16-35, and more preferably exhibits a CV value of 18-22. The CV value can be determined by the following Equation X.

CV value (%)={(Standard deviation)/(Arithmetic average particle diameter)}×100 Equation X

### The arithmetic average particle diameter is an average value of volume-based particle diameter x, measured for 25,000 toner particles using Coulter Multisizer III manufactured by Beckman Coulter Co., Ltd.

The volume-based median particle diameter of the toner is measured and calculated by using Coulter Multisizer III and a computer system for data processing, each manufactured by Beckman Coulter Co., Ltd. In concrete, 0.02 g of the toner is added to 20 ml of a surfactant solution for dispersing the toner, for example, a solution prepared by diluting a neutral detergent by 10 times by purified water, and wetted and then subjected to ultrasonic dispersion for 1 minute to prepare a toner dispersion. The toner dispersion is injected into a beaker set on the sample stand, in which an electrolyte solution Isoton II, manufactured by Beckman Coulter Co., Ltd., is contained, until the density indicated by the measuring apparatus becomes 5-10%. Measured values with high reproducibility can be obtained by making the density into such the range. The frequency is calculated by separating into 256 divisions in the range of 1-30 μm under conditions of a count number of the measuring particles of 25,000 and an aperture diameter of 50 μm, and the particle diameter at a point of 50% from the larger side of the volume accumulation ratio (volume D₅₀ % diameter) is defined as the volume median diameter.

### [Average Circularity of Toner Particle]

Each of the toner particles constituting the toner of the present invention preferably has an average circularity of 0.930-1.000 and more preferably 0.950-0.995. When the average circularity is within the range of 0.950-0.995, the filling density of the toner particles in the toner layer transferred onto the recording material and fixing suitability are improved so that the fixing offset is difficult to be generated. Moreover, the toner particles are difficult to be crushed so that the contamination of the frictional electrification providing member is reduced and the electrification of toner particles is stabilized.

The average circularity of the toner particles is a value measured by FPIA-2100, manufactured by Sysmex Co., Ltd. In concrete, the toner was wetted by an aqueous solution containing a surfactant and dispersed therein by ultrasonic wave for 1 minute, and then the toner particles are photographed in a suitable density by FPIA-2100, manufactured by Sysmex Co., Ltd., under conditions of HPF (high magnitude photographing) mode and a HPF detecting number of from 3,000 to 10,000. The circularity of each of toner particles is individually calculated according to the following Equation Y. The average circularity is obtained by adding the circularities of measured toner particles and being divided by the total number of the measured toner particles.

Circularity=(circumference length of a circle having an area equivalent to a projection of a particle)/(circumference length of a projection of a particle) Equation Y

### <Developer>

As to the toner of the present invention, any of a single-component magnetic toner containing a magnetic material, a double-component developer utilized by mixing with a carrier, and a non-magnetic toner used singly can preferably be used. In the case of the toner being used as the double-component developer by mixing with the carrier particles, occurrence of filming on the carrier particles (carrier contamination) can be inhibited and in the case of the single-component developer, occurrence of the toner filming on the triboelectricity donating member can be inhibited.

As the carrier constituting a double-component developer, known materials, for example, a metal such as iron, ferrite and magnetite, an alloy of aluminum or lead with the above metal can be used and ferrite is preferably used. The carrier preferably has a volume-based average particle diameter of 15-100 μm and more preferably 25-60 μm. The volume-based average particle diameter of the carrier can be measured by typically a laser diffraction type particle size distribution measuring apparatus equipped with a wet type homogenizer “HELOS”, manufactured by Sympatec Co., Ltd. As the carrier, a resin coated carrier or a rein dispersion type carrier in which magnetic particles are dispersed in a resin are preferably used. For the coating resin, for example, an olefin based resin, a styrene based resin, a styrene-acryl based resin, a silicone resin, an ester based resin and a fluorine-containing polymeric resin are usable though the resin is not specifically limited. Known resins such as a styrene-acryl based resin, a polyester based resin, a fluorine based resin and a phenol based resin can be used as the resin constituting the resin dispersion type carrier without any limitation.

### <Image Forming Method>

The above-described toners can be suitably used for an image forming method including a fixing process by contact heating method. In the image forming method, for example, an electrostatic latent image formed electrostatically on an image carrier is developed to form a toner image using the above developer charged by a friction electrification member in a developing device, and the developed image is transferred onto a recording material. The transferred material is fixed on the recording material by a fixing treatment by contact heating method to form a visible image.

### <Fixing Method>

As a suitable fixing method to use the toner of the present invention, a method called a contact heating system is applicable. The contact heating system includes a heat-fixing method, a heating roller system or a contact heating fixing system using a rotatable pressing member including a fixed heater.

In the fixing method as the heating roller fixing system, a fixing apparatus is usually used which is composed of an upper roller of a cylinder of metal such as iron and aluminum covered by a fluorine resin and a heat source is provided interior of the roller and a lower roller formed by silicone rubber. A line-shaped heater is used as the heat source and the surface of the upper roller is heated to a temperature 120-200° C. with a heater. Pressure is applied between the upper roller and the lower roller, and the lower roller is deformed by the pressure and a so-called nip is formed at the deformed portion. The width of the nip is 1-10 mm and preferably 1.5-7 mm. The line speed of fixation is preferably 40-600 mm/sec. When the nip width is too small, heat cannot be uniformly applied to the toner so that the fixation unevenness tends to be caused. When the nip width is too large, melting of the polyester is accelerated so that fixing offset tends to be caused.

As to the toner described above, since the toner particles are in a state where an aliphatic hydrocarbon group chemically bonded to the binder resin is present on the toner particle surface, the toner particle itself having low surface energy can be produced without generating image defects caused by an offset phenomenon via excessive negative electrification, and by movement of the low surface energy group to a photoreceptor or an intermediate transfer member. Accordingly, stable transferability can be obtained for a long duration, whereby high quality images can be stably formed for a long duration.

The embodiments of the present invention are described above, but the present invention is not limited to the above embodiments, and various changes can be added. For example, the production method of the toner of the present invention is not limited to the above-described method and a method may be applied in which, for example, a melted and kneaded material of the binder resin composed of the urea-modified polyester and the colorant is extruded through a die to form a rod and the rod-shaped material is crashed to form the toner particles.

### EXAMPLE

Examples conducted to confirm the effect of the present invention are described below, but the present invention is not limited thereto.

### Synthesizing Example of Isocyanate-Modified Polyester

Into a reaction vessel fitted with a stirrer and a nitrogen introducing tube, 724 parts by weight of bisphenol A with 2 moles of ethyleneoxide adduct, 200 parts by weight of isophthalic acid, 70 parts by weight of fumalic acid and 2 parts by weight of dibutyl tin oxide were charged and reacted at 230° C. for 8 hours at ordinary pressure, and further reacted for 5 hours under a reduced pressure of 12 mmHg, and then cooled to 160° C. After that, 32 parts by weight of phthalic anhydride was added and reacted for 2 hours to obtain polyester [a1]. Polyester [a1] had a glass transition temperature Tg of 59° C., a softening temperature of 121° C., a number average molecular weight (Mn) of 6,000 and a weight average molecular weight (Mw) of 28,000. To 1,000 parts by weight of polyester [a1], 2,000 parts by weight of ethyl acetate were charged and then 120 parts by weight of isophorone diisocyanate was added, and reacted at 80° C. for 2 hours to obtain Isocyanate-modified Polyester [A1].

### Toner Preparation Example Bk1

In a mixing vessel fitted with a liquid seal (refluxing device) and a stirrer, 450 parts by weight of ethyl acetate, 300 parts by weight of isocyanate-modified polyester [A1], 14 parts by weight of isophoronediamine, 4 parts by weight of copper phthalocyanine blue, 4 parts by weight of carbon black and 15 parts by weight of pentaerythritol tetrastearate were mixed at 20° C. for 2 hours to obtain toner composition [1]. On the other hand, 600 parts by weight of deionized water, 60 parts by weight of methylethyl ketone, 60 parts by weight of tricalcium phosphate, 0.3 parts by weight of sodium dodecylbenzenesulfonate were charged in another reaction vessel, and the above toner composition [1] was poured into the vessel and dispersed in an aqueous medium while stirring at 30° C. and at 15,000 rpm for 3 minutes employing a KT type Homomixer, manufactured by Tokushu Kika Kogyo Co., Ltd. Then the resulting was heated to 80° C. and a urea reaction treatment was conducted for 10 hours. Intermediate particle [1] obtained here had a volume-based median particle diameter of 5.3 μm as an average particle diameter. Next, After decanting intermediate particle [1] to another stirring vessel to add 0.3 parts by weight of sodium dodecylsulfate at 30° C., a composition formed from 1.5 parts by weight of dodecyl alcohol and 50 parts by weight of ethyl acetate was dripped, heated to 50° C., reacted for 3 hours to chemically bond a dodecyl group to the particle surface, and subsequently heated rapidly to 80° C. to remove ethyl acetate. After complete removal of ethyl acetate, the system was cooled down to room temperature, 150 parts by weight of 35% concentrated hydrochloric acid was introduced to elute tricalcium phosphate on the particle surface. Next, solid-liquid separation was conducted, a dehydrated toner cake was dispersed again in deionized water to conduct such the solid-liquid separation three times, and cleaning and drying at 40° C. for 24 hours were carried out to obtain toner mother particle [Bk1]. Into 100 parts by weight of the resulting toner mother particle [Bk1], 0.6 parts by weight of hydrophobic silica and 1.0 part by weight of hydrophobic titanium oxide were mixed employing HENSCHEL MIXER to obtain toner [Bk1] formed from toner particle [Bk1]. Mixing was conducted at 32° C. for 20 minutes at a circumference speed of the HENSCHEL MIXER of 35 m/sec., and subsequently, the toner was passed through a sieve having a mesh of 45 μm.

### Toner Preparation Example Y1

Toner [Y1] was prepared similarly to toner preparation example Bk1, except that 4 parts by weight of copper phthalocyanine blue and 4 parts by weight of carbon black were replaced by 8 parts by weight of Pigment Yellow 74.

### Toner Preparation Example M1

Toner [M1] was prepared similarly to toner preparation example Bk1, except that 4 parts by weight of copper phthalocyanine blue and 4 parts by weight of carbon black were replaced by 8 parts by weight of Pigment Red 122.

### Toner Preparation Example C1

Toner [C1] was prepared similarly to toner preparation example Bk1, except that 4 parts by weight of copper phthalocyanine blue and 4 parts by weight of carbon black were replaced by 8 parts by weight of copper phthalocyanine blue.

The above-described toner [Bk1], toner [Y1], toner [M1] and toner [C1] each had a volume-based median particle diameter of 5.2 μm, an average circularity of 0.964, a glass transition temperature (Tg) of 61° C., a softening temperature of 125° C., a number average molecular weight (Mn) of 12,000 and a weight average molecular weight (Mw) of 62,000, together with a CV value of 21.

### Synthesizing Example of Isocyanate-Modified Polyester 2

First, 1,500 parts by weight of sebacic acid, 964 parts by weight of hexamethylene glycol and 2 parts by weight of dibutyl tin oxide were charged into a reaction vessel of a 5 L round bottom flask fitted with a thermometer, a stirrer, a nitrogen gas introducing tube and a streamwise type condenser. Next, the reaction vessel was placed on a mantle heater and heated to 150° C. at nitrogen gas atmosphere in the inside of reaction vessel. Subsequently, 13.2 parts by weight of p-toluenesulfonic acid was added and reacted. Reaction was terminated at a time when an amount of water distillated out via esterification reaction the reaction reached 250 parts by weight, and the reaction system was cooled to room temperature to obtain polyester [a2] formed from polyhexamethylene sebacate having a hydroxyl group at a molecular terminal. Polyester [a2] had a melting point (Tm) of 64° C., a weight average molecular weight (Mw) of 3,500 and a number average molecular weight (Mn) of 2,000, measured by GPC. Next, 2,000 parts by weight of ethyl acetate, 1,000 parts by weight of polyester [a2] were charged in a reaction vessel fitted with a stirrer and a nitrogen introducing tub, heated to 80° C., and then 200 parts by weight of isophorone diisocyanate was added and reacted for 2 hours to obtain isocyanate-modified polyester [A2].

### Toner Preparation Example Bk2

In a mixing vessel fitted with a liquid seal (refluxing device) and a stirrer, 450 parts by weight of ethyl acetate, 267 parts by weight of isocyanate-modified polyester [A1], 37 parts by weight of isocyanate-modified polyester [A2], 17 parts by weight of isophoronediamine, 4 parts by weight of copper phthalocyanine blue, 4 parts by weight of carbon black and 15 parts by weight of pentaerythritol tetrastearate were mixed at 20° C. for 2 hours to obtain toner composition [2]. On the other hand, 600 parts by weight of deionized water, 60 parts by weight of methylethyl ketone, 60 parts by weight of tricalcium phosphate, 0.3 parts by weight of sodium dodecylbenzenesulfonate were charged in another reaction vessel, and the above toner composition [2] was poured into the vessel and dispersed in an aqueous medium while stirring at 30° C. and at 12,000 rpm for 3 minutes employing a KT type Homomixer, manufactured by Tokushu Kika Kogyo Co., Ltd. Then the resulting was heated to 80° C. and a urea reaction treatment was conducted for 10 hours. Intermediate particle [2] obtained here had a volume-based median particle diameter of 5.3 μm as an average particle diameter. Next, After decanting intermediate particle [2] to another stirring vessel to add 0.3 parts by weight of sodium dodecylsulfate at 30° C., a composition formed from 1.5 parts by weight of dodecyl alcohol and 50 parts by weight of ethyl acetate was dripped, heated to 50° C., reacted for 3 hours to chemically bond a dodecyl group to the particle surface, and subsequently heated rapidly to 80° C. to remove ethyl acetate. After complete removal of ethyl acetate, the system was cooled down to room temperature, 150 parts by weight of 35% concentrated hydrochloric acid was introduced to elute tricalcium phosphate on the particle surface. Next, solid-liquid separation was conducted, a dehydrated toner cake was dispersed again in deionized water to conduct such the solid-liquid separation three times, and cleaning and drying at 40° C. for 24 hours were carried out to obtain toner mother particle [Bk2]. Into 100 parts by weight of the resulting toner mother particle [Bk2], 0.6 parts by weight of hydrophobic silica and 1.0 part by weight of hydrophobic titanium oxide were mixed employing HENSCHEL MIXER to obtain toner [Bk2] formed from toner particle [Bk2]. Mixing was conducted at 32° C. for 20 minutes at a circumference speed of the HENSCHEL MIXER of 35 m/sec., and subsequently, the toner was passed through a sieve having a mesh of 45 μm.

### Toner Preparation Example Y2

Toner [Y2] was prepared similarly to toner preparation example Bk2, except that 4 parts by weight of copper phthalocyanine blue and 4 parts by weight of carbon black were replaced by 8 parts by weight of Pigment Yellow 74.

### Toner Preparation Example M2

Toner [M2] was prepared similarly to toner preparation example Bk2, except that 4 parts by weight of copper phthalocyanine blue and 4 parts by weight of carbon black were replaced by 8 parts by weight of Pigment Red 122.

### Toner Preparation Example C2

Toner [C2] was prepared similarly to toner preparation example Bk2, except that 4 parts by weight of copper phthalocyanine blue and 4 parts by weight of carbon black were replaced by 8 parts by weight of copper phthalocyanine blue.

The above-described toner [Bk2], toner [Y2], toner [M2] and toner [C2] each had a volume-based median particle diameter of 5.2 μm, an average circularity of 0.964, a glass transition temperature (Tg) of 49° C., a softening temperature of 98° C., a number average molecular weight (Mn) of 10,500 and a weight average molecular weight (Mw) of 38,000, together with a CV value of 21.

### Toner Preparation Example Bk3

Toner [Bk3] was prepared similarly to toner preparation example Bk1, except that 1.5 parts by weight of dodecyl alcohol was replaced by 2 parts by weight of hexadecyl alcohol.

### Toner Preparation Example Y3

Toner [Y3] was prepared similarly to toner preparation example Bk3, except that 4 parts by weight of copper phthalocyanine blue and 4 parts by weight of carbon black were replaced by 8 parts by weight of Pigment Yellow 74.

### Toner Preparation Example M3

Toner [M3] was prepared similarly to toner preparation example Bk3, except that 4 parts by weight of copper phthalocyanine blue and 4 parts by weight of carbon black were replaced by 8 parts by weight of Pigment Red 122.

### Toner Preparation Example C3

Toner [C3] was prepared similarly to toner preparation example Bk3, except that 4 parts by weight of copper phthalocyanine blue and 4 parts by weight of carbon black were replaced by 8 parts by weight of copper phthalocyanine blue.

The above-described toner [Bk3], toner [Y3], toner [M3] and toner [C3] each had a volume-based median particle diameter of 5.1 μm, an average circularity of 0.968, a glass transition temperature (Tg) of 61° C., a softening temperature of 125° C., a number average molecular weight (Mn) of 12,000 and a weight average molecular weight (Mw) of 62,000, together with a CV value of 21.

### Toner Preparation Example Bk4

Toner [Bk4] was prepared similarly to toner preparation example Bk2, except that dodecyl alcohol was replaced by hexadecyl alcohol.

### Toner Preparation Example Y4

Toner [Y4] was prepared similarly to toner preparation example Bk4, except that 4 parts by weight of copper phthalocyanine blue and 4 parts by weight of carbon black were replaced by 8 parts by weight of Pigment Yellow 74.

### Toner Preparation Example M4

Toner [M4] was prepared similarly to toner preparation example Bk4, except that 4 parts by weight of copper phthalocyanine blue and 4 parts by weight of carbon black were replaced by 8 parts by weight of Pigment Red 122.

### Toner Preparation Example C4

Toner [C4] was prepared similarly to toner preparation example Bk4, except that 4 parts by weight of copper phthalocyanine blue and 4 parts by weight of carbon black were replaced by 8 parts by weight of copper phthalocyanine blue.

The above-described toner [Bk4], toner [Y4], toner [M4] and toner [C4] each had a volume-based median particle diameter of 5.2 μm, an average circularity of 0.964, a glass transition temperature (Tg) of 49° C., a softening temperature of 98° C., a number average molecular weight (Mn) of 10,500 and a weight average molecular weight (Mw) of 38,000, together with a CV value of 21.

### Toner Preparation Example Bk5

Toner [Bk5] was prepared similarly to toner preparation example Bk2, except that dodecyl alcohol was replaced by docosyl alcohol.

### Toner Preparation Example Y5

Toner [Y53] was prepared similarly to toner preparation example Bk5, except that 4 parts by weight of copper phthalocyanine blue and 4 parts by weight of carbon black were replaced by 8 parts by weight of Pigment Yellow 74.

### Toner Preparation Example M5

Toner [M5] was prepared similarly to toner preparation example Bk4, except that 4 parts by weight of copper phthalocyanine blue and 4 parts by weight of carbon black were replaced by 8 parts by weight of Pigment Red 122.

### Toner Preparation Example C5

Toner [C5] was prepared similarly to toner preparation example Bk5, except that 4 parts by weight of copper phthalocyanine blue and 4 parts by weight of carbon black were replaced by 8 parts by weight of copper phthalocyanine blue.

The above-described toner [Bk5], toner [Y5], toner [M5] and toner [C5] each had a volume-based median particle diameter of 5.2 μm, an average circularity of 0.964, a glass transition temperature (Tg) of 48° C., a softening temperature of 97° C., a number average molecular weight (Mn) of 10,500 and a weight average molecular weight (Mw) of 38,000, together with a CV value of 21.

### Toner Preparation Example Bk6

Toner [Bk6] was prepared similarly to toner preparation example Bk2, except that 1.5 parts by weight of dodecyl alcohol was replaced by 5 parts by weight of octacosyl alcohol.

### Toner Preparation Example Y6

Toner [Y6] was prepared similarly to toner preparation example Bk6, except that 4 parts by weight of copper phthalocyanine blue and 4 parts by weight of carbon black were replaced by 8 parts by weight of Pigment Yellow 74.

### Toner Preparation Example M6

Toner [M6] was prepared similarly to toner preparation example Bk6, except that 4 parts by weight of copper phthalocyanine blue and 4 parts by weight of carbon black were replaced by 8 parts by weight of Pigment Red 122.

### Toner Preparation Example C6

Toner [C6] was prepared similarly to toner preparation example Bk6, except that 4 parts by weight of copper phthalocyanine blue and 4 parts by weight of carbon black were replaced by 8 parts by weight of copper phthalocyanine blue.

The above-described toner [Bk6], toner [Y6], toner [M6] and toner [C6] each had a volume-based median particle diameter of 5.2 μm, an average circularity of 0.968, a glass transition temperature (Tg) of 47° C., a softening temperature of 97° C., a number average molecular weight (Mn) of 10,500 and a weight average molecular weight (Mw) of 38,000, together with a CV value of 21.

### Toner Preparation Example Bk7

Toner [Bk7] was prepared similarly to toner preparation example Bk2, except that 1.5 parts by weight of dodecyl alcohol was replaced by 4 parts by weight of docosanoic acid.

### Toner Preparation Example Y7

Toner [Y7] was prepared similarly to toner preparation example Bk7, except that 4 parts by weight of copper phthalocyanine blue and 4 parts by weight of carbon black were replaced by 8 parts by weight of Pigment Yellow 74.

### Toner Preparation Example M7

Toner [M7] was prepared similarly to toner preparation example Bk7, except that 4 parts by weight of copper phthalocyanine blue and 4 parts by weight of carbon black were replaced by 8 parts by weight of Pigment Red 122.

### Toner Preparation Example C7

Toner [C7] was prepared similarly to toner preparation example Bk7, except that 4 parts by weight of copper phthalocyanine blue and 4 parts by weight of carbon black were replaced by 8 parts by weight of copper phthalocyanine blue.

The above-described toner [Bk7], toner [Y7], toner [M7] and toner [C7] each had a volume-based median particle diameter of 5.2 μm, an average circularity of 0.964, a glass transition temperature (Tg) of 49° C., a softening temperature of 98° C., a number average molecular weight (Mn) of 10,500 and a weight average molecular weight (Mw) of 38,000, together with a CV value of 21.

### Toner Preparation Example Bk8

Toner [Bk8] was prepared similarly to toner preparation example Bk2, except that 1.5 parts by weight of dodecyl alcohol was replaced by 4 parts by weight of docosyl amine.

### Toner Preparation Example Y8

Toner [Y8] was prepared similarly to toner preparation example Bk8, except that 4 parts by weight of copper phthalocyanine blue and 4 parts by weight of carbon black were replaced by 8 parts by weight of Pigment Yellow 74.

### Toner Preparation Example M8

Toner [M8] was prepared similarly to toner preparation example Bk8, except that 4 parts by weight of copper phthalocyanine blue and 4 parts by weight of carbon black were replaced by 8 parts by weight of Pigment Red 122.

### Toner Preparation Example C8

Toner [C8] was prepared similarly to toner preparation example Bk8, except that 4 parts by weight of copper phthalocyanine blue and 4 parts by weight of carbon black were replaced by 8 parts by weight of copper phthalocyanine blue.

The above-described toner [Bk8], toner [Y8], toner [M8] and toner [C8] each had a volume-based median particle diameter of 5.2 μm, an average circularity of 0.964, a glass transition temperature (Tg) of 49° C., a softening temperature of 98° C., a number average molecular weight (Mn) of 10,500 and a weight average molecular weight (Mw) of 38,000, together with a CV value of 21.

### Comparative Toner Preparation Example Bk9

Comparative toner [Bk9] was prepared similarly to toner preparation example Bk1, except that dodecyl alcohol was not used.

### Comparative Toner Preparation Example Y9

Comparative toner [Y9] was prepared similarly to comparative toner preparation example Bk9, except that 4 parts by weight of copper phthalocyanine blue and 4 parts by weight of carbon black were replaced by 8 parts by weight of Pigment Yellow 74.

### Comparative Toner Preparation Example M9

Comparative toner [M9] was prepared similarly to comparative toner preparation example Bk9, except that 4 parts by weight of copper phthalocyanine blue and 4 parts by weight of carbon black were replaced by 8 parts by weight of Pigment Red 122.

### Comparative Toner Preparation Example C9

Comparative toner [C9] was prepared similarly to toner preparation example Bk9, except that 4 parts by weight of copper phthalocyanine blue and 4 parts by weight of carbon black were replaced by 8 parts by weight of copper phthalocyanine blue.

The above-described comparative toner [Bk9], comparative toner [Y9], comparative toner [M9] and comparative toner [C9] each had a volume-based median particle diameter of 5.2 μm, an average circularity of 0.964, a glass transition temperature (Tg) of 61° C., a softening temperature of 125° C., a number average molecular weight (Mn) of 12,000 and a weight average molecular weight (Mw) of 62,000, together with a CV value of 21.

### Comparative Toner Preparation Example Bk10

Comparative toner [Bk10] was prepared similarly to toner preparation example Bk2, except that dodecyl alcohol was not used.

### Comparative Toner Preparation Example Y10

Comparative toner [Y10] was prepared similarly to comparative toner preparation example Bk10, except that 4 parts by weight of copper phthalocyanine blue and 4 parts by weight of carbon black were replaced by 8 parts by weight of Pigment Yellow 74.

### Comparative Toner Preparation Example M10

Comparative toner [M10] was prepared similarly to comparative toner preparation example Bk10, except that 4 parts by weight of copper phthalocyanine blue and 4 parts by weight of carbon black were replaced by 8 parts by weight of Pigment Red 122.

### Comparative Toner Preparation Example C10

Comparative toner [C10] was prepared similarly to toner preparation example Bk10, except that 4 parts by weight of copper phthalocyanine blue and 4 parts by weight of carbon black were replaced by 8 parts by weight of copper phthalocyanine blue.

The above-described comparative toner [Bk10], comparative toner [Y10], comparative toner [M10] and comparative toner [C10] each had a volume-based median particle diameter of 5.2 μm, an average circularity of 0.964, a glass transition temperature (Tg) of 49° C., a softening temperature of 98° C., a number average molecular weight (Mn) of 10,500 and a weight average molecular weight (Mw) of 38,000, together with a CV value of 21.

### Carrier Preparation Example

A coating liquid composed of 85 parts by weight of silicone resin (oxime curing type, toluene solution) as a solid content, 10 parts by weight of γ-aminopropyltrimethoxysilane (coupling agent), 3 parts by weight of alumina particles (a particle diameter of 100 nm) and 2 parts by weight of carbon black was spray-coated onto a Mn—Mg ferrite having a weight average particle diameter of 50 μm, baked at 190° C. for 6 hours, and subsequently cooled to room temperature to obtain a resin coating type carrier. The resin coated layer had an average thickness of 0.2 μm.

### Developer Preparation Example

Ninety four parts by weight of the above prepared carrier and each of 6 parts by weight of the above prepared toners [Bk1]-[C8] and comparative toners [Bk9]-[C10] were mixed by a V-type mixer to prepare each of developers [Bk1]-[C8] and comparative developers [Bk9]-[C10]. The mixing treatment was terminated at a time when a charging amount of toner reached 20-23 μC/g to take the admixture out once into a polyethylene pot.

### Examples 1-8, and Comparative Examples 1-2

Developers [Bk1]-[C8] and comparative developers [Bk9] [C10] were used in combination as shown in Table 1, the transferability and stability of the resulting full color image were evaluated by the following method at low temperature and low humidity (10° C. and 20% RH) and at high temperature and high humidity (33° C. and 85% RH) employing a digital copying machine “bizhub C500”, manufactured by Konica Minolta Holdings. Inc. Results are shown in Table 1.

### <Evaluation of Transferability>

Employing an A4 size sheet including 100 letters of 8- point character in roman font such as letter “ [symbol] ”, the 20,000 sheets were printed. Subsequently, a text image at an initial stage and the resulting text Image after printing the 20,000 sheets were enlarged 20 times, and lack of line image of transfer was observed. The lack of line image of transfer was evaluated by using the number of letters having the lack of line image of transfer in the 100 letters.

### <Stability of Full Color Image>

As to yellow, magenta, cyan, red, blue and green, 20,000 images were continuously formed on A4 size sheets employing an each color patch image of a square, 1 cm on a side having a pixel ratio of 5%, each color patch image obtained after forming the 20,000 images were designated as an L*a*b* color system, provided that L* represents lightness, a* represents color in the red-green direction, and b* represents the yellow-blue direction, color space area was measured by the resulting a* coordinate and b* coordinate after setting an initial color space area to 100% to evaluate stability of the full color image. In addition, when this color space area is at least 90%, it is conventionally usable with no problem, but this color space area is preferably at least 95% in the light printing field.

TABLE 1

| | | | | | | Stability of | |
|---|---|---|---|---|---|---|---|
| | | | | | | full color | |
| | | Transferability | | | | image | |
| | | *2 | | *3 | | (%) | |
| | *1 | *4 | *5 | *4 | *5 | *2 | *3 |
| Example 1 | Bk1/Y1/ | 0 | 1 | 0 | 1 | 98 | 97 |
| | M1/C1 | | | | | | |
| Example 2 | Bk2/Y2/ | 0 | 1 | 0 | 0 | 98 | 97 |
| | M2/C2 | | | | | | |
| Example 3 | Bk3/Y3/ | 0 | 0 | 0 | 0 | 98 | 98 |
| | M3/C3 | | | | | | |
| Example 4 | Bk4/Y4/ | 0 | 0 | 0 | 0 | 98 | 97 |
| | M4/C4 | | | | | | |
| Example 5 | Bk5/Y5/ | 0 | 0 | 0 | 0 | 98 | 97 |
| | M5/C5 | | | | | | |
| Example 6 | Bk6/Y6/ | 0 | 0 | 0 | 0 | 98 | 97 |
| | M6/C6 | | | | | | |
| Example 7 | Bk7/Y7/ | 0 | 0 | 0 | 0 | 98 | 97 |
| | M7/C7 | | | | | | |
| Example 8 | Bk8/Y8/ | 0 | 0 | 0 | 0 | 98 | 97 |
| | M8/C8 | | | | | | |
| Comparative | Bk9/Y9/ | 5 | 56 | 7 | 67 | 94 | 89 |
| example 1 | M9/C9 | | | | | | |
| Comparative | Bk10/ | 5 | 54 | 6 | 67 | 92 | 87 |
| example 2 | Y10/M10/ | | | | | | |
| | C10 | | | | | | |

*1: Developers used in combination
*2: At low temperature and low humidity
*3: At high temperature and high humidity
*4: At initial printing stage
*5: After printing the 20,000 sheets

As is clear from Table 1, it is to be understood that toners of Examples 1-8 exhibited stable transferability for a long duration, images were also possible to be stably formed for a long duration.

As to the toner of the present invention, since toner particles are in a state where an aliphatic hydrocarbon group chemically bonded to the binder resin is present on the toner particle surface, the toner particle itself having low surface energy can be produced without generating image defects caused by an offset phenomenon via excessive negative electrification, and by movement of the low surface energy group to a photoreceptor or an intermediate transfer member. Accordingly, stable transferability can be obtained for a long duration, whereby high quality images can be stably formed for a long duration.

What is claimed is:

1. A toner comprising toner particles each containing a binder resin and a colorant,
wherein the toner particle has an aliphatic hydrocarbon group chemically bonded to the binder resin on a surface of the toner particle, and
the binder resin is urea-modified polyester.

2. The toner of claim 1,
wherein the aliphatic hydrocarbon group has 8-30 carbon atoms.

3. The toner of claim 2,
wherein the aliphatic hydrocarbon group is straight-chained.

4. The toner of claim 2,
comprising the aliphatic hydrocarbon group in an amount of 0.01-5% by weight, based on the total weight of toner.

5. The toner of claim 1,
wherein the urea-modified polyester has a weight average molecular weight of 5,000-500,000.

6. The toner of claim 1,
wherein the urea-modified polyester has a number average molecular weight of 3,500-400,000.

7. The toner of claim 1,
wherein the urea-modified polyester has an acid value of 5-45 mgKOH/g.

8. The toner of claim 1,
wherein the urea-modified polyester has a glass transition temperature (Tg) of 30-60° C.

9. The toner of claim 1,
wherein the urea-modified polyester has a softening temperature of 70-110° C.

10. The toner of claim 1,
wherein the aliphatic hydrocarbon group has 12-25 carbon atoms.

11. The toner of claim 1,
wherein the aliphatic hydrocarbon group is straight-chained.

12. The toner of claim 1,
comprising the aliphatic hydrocarbon group in an amount of 0.01-5% by weight, based on the total weight of toner.

13. The toner of claim 1,
wherein the toner particle has a volume-based median particle diameter of 3-8 μm.

14. The toner of claim 1,
wherein a particle size distribution of the toner exhibits a CV value 16-35.

15. The toner of claim 1,
wherein the toner has an average circularity of 0.930-1.000.

16. A toner comprising toner particles each containing a binder resin and a colorant,
wherein the toner particle has an aliphatic hydrocarbon group that is present on the toner particle surface.

17. The toner of claim 16,
wherein the binder resin is polyester.

18. The toner of claim 17,
wherein the aliphatic hydrocarbon group chemically bonded to the binder resin is present on a colored particle surface by chemically reacting a compound comprising the aliphatic hydrocarbon group.

19. The toner of claim 16,
wherein the binder resin comprises urea-modified polyester.

20. The toner of claim 16,
wherein the aliphatic hydrocarbon group has 8-30 carbon atoms.

21. The toner of claim 16,
wherein the urea-modified polyester has a weight average molecular weight of 5,000-500,000 and a number average molecular weight of 3,500-400,000.

22. The toner of claim 16,
wherein the urea-modified polyester has an acid value of 5-45 mgKOH/g.

23. The toner of claim 16,
wherein the aliphatic hydrocarbon group has 12-25 carbon atoms.

24. The toner of claim 16,
wherein the aliphatic hydrocarbon group is straight-chained.

25. The toner of claim 16,
comprising the aliphatic hydrocarbon group in an amount of 0.01-5% by weight, based on the total weight of toner.
